(19) United States
(12) Patent Application Publication
(10) Pub. No.: US 2002/0184985 A1
(43) Pub. Date: Dec. 12, 2002

(54) ROTARY CUTOFF APPARATUS

(75) Inventors: HIROSHI ISHIBUCHI, HIROSHIMA-KEN (JP); HIROYUKI TAKENAKA, HIROSHIMA-KEN (JP); TOSHIHIDE KATO, HIROSHIMA-KEN (JP)

Correspondence Address: ARMSTRONG,WESTERMAN & HATTORI, LLP, 1725 K STREET, NW., SUITE 1000, WASHINGTON, DC, 20006, US

(73) Assignee: MITSUBISHI HEAVY INDUSTRIES, LTD

(21) Appl. No.: 09/126,766

(22) Filed: Jul. 31, 1998

(30) Foreign Application Priority Data
Apr. 9, 1997 (JP) HEI-9-239493

(51) Int. Cl. B26D 1/62

(52) U.S. Cl. 83/342; 83/582; 83/672

(57) ABSTRACT

This invention relates to a rotary cutoff apparatus, which permits easy speed control without needing high-level skill or technique and also allows ready replacement of its anvil member. The apparatus is provided with a knife cylinder, which has a knife arranged on its outer circumferential surface and is rotatably supported, and an anvil member with which a free edge of the knife can be brought into contact upon rotation of the knife cylinder, whereby a travelling band-shaped sheet is nipped between the knife and the anvil member and is hence cut off. The knife is supported on the knife cylinder via a spring having spring force sufficient to bear cutting force required to cut off the band-shaped sheet so that the knife is displaceable in a loaded direction upon cutting off the band-shaped sheet. The rotary cutoff apparatus according to the present invention can be arranged, for example, in a production line for a band-shaped sheet material such as a corrugated fiberboard sheet.

### BACKGROUND OF THE INVENTION

1) Field of the Invention

This invention relates to a rotary cutoff apparatus, which is arranged, for example, in a production line for a band-shaped sheet material such as a corrugated fiberboard sheet to cut off the corrugated fiberboard sheet, which has been continuously fed from a preceding step, into predetermined lengths.

2) Description of the Related Art

Conventional corrugated fiberboard cutoff apparatuses include an apparatus such as that illustrated in FIGS. 5 and 6, in which FIG. 5 is a front view showing the cutoff apparatus with some parts thereof having been cut away and FIG. 6 is a cross-sectional view taken in the direction of arrows VI-VI of FIG. 5.

As is illustrated in FIG. 5, in this conventional corrugated fiberboard cutoff apparatus, an upper knife cylinder 102 and a lower knife cylinder 103 located above and below a sheet pass line 101L (see FIG. 6), on and along which a corrugated fiberboard (sheet) 101 is fed, are arranged in a mutually-opposing relationship. This upper knife cylinder 102 and lower knife cylinder 103 may hereinafter be referred to simply as “the knife cylinders 102,103”. Via bearings 105,106, both of these knife cylinders 102,103 are rotatably supported on frames 104a, 104b, which are arranged upright on the sides of opposite ends of the knife cylinders 102,103 (on both sides of the production line), respectively.

Gears 107 are fixedly secured on the opposite ends of the upper knife cylinder 102, respectively. Likewise, gears 108 are fixedly mounted on the opposite ends of the lower knife cylinder 103. These gears 107 and 108 are arranged in meshing engagement at a 1:1 gear ratio. Namely, owing to the meshing engagement of the gears 107 with their corresponding gears 108 at the 1:1 gear ratio, the upper knife cylinder 102 and the lower knife cylinder 103 synchronously rotate in the mutually-opposing relationship.

These knife cylinders 102,103 are provided on circumferential surfaces thereof with helical knives 113,114, respectively. Upon rotation of the knife cylinders 102,103 in the mutually-opposing relationship, these knives 113,114 are brought into nipping engagement with each other once every full rotation and the point of the nipping engagement successively moves alongside axes of the knife cylinders 102,103 (in other words, from the side of one end of each knife cylinder toward its opposite end), whereby the corrugated fiberboard sheet 101 traveling on and along the sheet pass line 101L is cut off.

In FIG. 5, numeral 109 indicates an electric motor which supplies power for rotational drive. To transmit power from the electric motor 109, a gear 111 fitted on a motor shaft 110 is arranged in mesh with a gear 112 which is fitted on an end portion of a shaft of the lower knife cylinder 103.

Upon feeding the sheet 101, the knife cylinders 102,103 arranged side by side in combination above and below the sheet pass line 101L are rotated in the mutually-opposing relationship. As a result of the rotation of the knife cylinders 102,103, the upper and lower knives 113,114 are brought into nipping engagement owing to the above-described construction, thereby cutting off the sheet 101.

In such a corrugated fiberboard cutoff apparatus as described above, rotational control is however needed to make the upper and lower knife cylinders 102,103 rotate at the same speed subsequent to a deceleration or acceleration so that the sheet 101 can be cut off in predetermined lengths in accordance with a feeding speed as required. Namely, there is a problem with the above-mentioned corrugated fiberboard cutoff apparatus in that the overall rotary inertia GD² required to rotate the knife cylinders 102,103 in the opposing relationship becomes great due to the adoption of the cutting method making use of the nipping engagement of both the knives 113,114.

In addition to the rotary inertia of the knife cylinders 102,103, the rotary inertia of the connecting gears (gears 111,112) for synchronization also becomes a load on the electric motor 109 as the drive source, resulting in a need for the arrangement of an electric motor of large power as the electric motor 109.

As a countermeasure to this problem, the design of a rotary system such as the knife cylinders 102,103 and the gears 107,108,111,112 with small rotary inertia may be contemplated. A reduction in the rotary inertia, however, leads to reductions in the flexural rigidity and torsional rigidity of the knife cylinders 102,103, thereby deteriorating the cutting performance of the knives 113,114 or failing to achieve precise nipping engagement between the knives 113 and 114 so that cutting-off may not be achieved in some instances.

Further, to assure good cutting quality, an adjustment of nipping engagement between the knives 113 and 114 requires setting of an adequate preload or clearance. Accuracy is required for the fabrication and assembly of a backlash eliminator and other components in a mechanical system. Accordingly, in addition to high technical skill and substantial time and labor for adjustments, high accuracy is also required for the fabrication of drive gears, resulting in problems such as a rise in the manufacturing cost.

Since the mutual contact and sliding between the knives 113 and 114 are the basic cutting mechanisms of this cutting method as mentioned above, an increase in the friction between the knives cannot be avoided. There is accordingly inconvenience in that more frequent scheduled or on-demand adjustments of nipping engagement between the knives and also more frequent scheduled or on-demand grinding or replacement of their cutting edges are needed, resulting in significant reductions in the rate of operation and productivity of the apparatus.

With a view to overcoming the above-mentioned problems, a corrugated fiberboard cutoff apparatus, for example, such as that shown in FIGS. 7 and 8 has been proposed. A description will hereinafter be made about the corrugated fiberboard cutoff apparatus with reference to FIGS. 7 and 8, in which FIG. 7 is a front view of the apparatus with some parts thereof having been cut away and FIG. 8 is a cross-sectional view taken in the direction of VIII-VIII of FIG. 7.

The corrugated fiberboard cutoff apparatus shown in FIG. 7 comprises a knife cylinder 116 and an anvil-wrapped roll (anvil cylinder) 117. The knife cylinder 116 carries a knife 115 mounted in a helical form on a circumferential surface thereof and is rotatably supported. The anvil-wrapped roll 117 is arranged in parallel with the knife cylinder 116, and is rotatably supported so that the knife 115 is successively brought into nipping engagement with the anvil-wrapped roll 117 from one end toward an opposite end of the knife cylinder 116 as the knife cylinder 116 rotates.

The knife cylinder 116 is rotated by an electric motor 118 under acceleration or deceleration control according to a cut length so that cutting operation can be started at a speed harmonized with a travelling speed of the sheet 101. Incidentally, this electric motor 118 comprises, for example, a servomotor and is controlled by an unillustrated controller.

By another electric motor 119 different from the electric motor 118, the anvil-wrapped roll 117 is rotationally driven in harmonization with the travelling speed of the sheet 101. In a similar manner as in the apparatus mentioned above with reference to FIG. 5, a gear 120 fitted on a motor shaft 110 is driven by this electric motor 119 in mesh with a gear 121 fitted on an end portion of a shaft of the anvil-wrapped roll 117 so that power is transmitted. Incidentally, as is shown in FIG. 8, an anvil layer (layered anvil member) 122 is wrapped in an endlessly connected form on and around this anvil-wrapped roll 117.

Owing to the construction as described above, upon feeding the sheet 101, the anvil-wrapped roll 117 is rotationally driven in harmonization with the travelling speed of the sheet 101 and, to permit initiation of the next cutting operation for obtaining a predetermined cut length, rotation of the knife cylinder 116 is controlled for a deceleration or an acceleration in harmonization with the travelling speed of the sheet 101, so that the knife 115 on the knife cylinder 116 begins cutting operation at a speed harmonized with the travelling speed of the sheet 101. Nipping engagement then progressively takes place from an end toward an opposite end of the anvil layer 122 on the anvil-wrapped roll 117.

As it is necessary to conduct acceleration/deceleration control on only one cylinder, that is, the knife cylinder 116 in this case, the rotary inertia (GD²) can be reduced. This makes it possible to use a smaller electric motor as a drive means, i.e., as the electric motor 118 and also to facilitate the speed control. In addition, as only one of the upper and lower rolls (the knife cylinder 116 and the anvil-wrapped roll 117) is provided with the knife 115, it is no longer necessary to perform any nipping adjustment between knives, thereby obviating high-level skill or technique.

By the way, the anvil-wrapped roll 117 depicted in FIG. 7 is constructed as an anvil, which is arranged opposite the single knife blade, by wrapping the plate-shaped material (anvil layer 122). The anvil layer 122 therefore cannot remain free from penetration damage (indentations) and strike damage (dents) during cutting.

When the anvil layer 122 develops damage such as dents, the anvil layer 122 shows ductility in an angular direction due to wedging effects, leading to an enlargement of the initial diameter of the anvil layer due to a resulting angular elongation. As a result, deformation such as unnatural waving are formed so that the anvil-wrapped roll 117 prematurely becomes unusable.

If this anvil layer 122 is formed with a hard material such as a hard alloy or ceramic, the anvil layer would be broken due to the brittle property of the hard material when it is subjected to flexural deformation upon its wrapping on and around a roll (the anvil-wrapped roll 117 or the like). From the practical standpoint, the thickness of the hard material is therefore limited to one several tenths of a millimeter or smaller. Under the overwhelming requirement toward an anvil having as great a thickness as possible in view of durability, the use of such a hard material is not considered to be practical.

As an alternative, the construction of the anvil-wrapped roll 117 itself as a cylinder (anvil cylinder) in the form of a hard anvil of an integral or solid structure without wrapping it with the anvil layer 122 may be contemplated. This cylinder must be provided with sufficient rigidity because it is exposed to cutting loads from the upper knife cylinder 116. The cylinder must therefore be formed into one having a large diameter and a large mass. Moreover, it is only the surface layer that is actually used. Such a cylinder is hence uneconomical, and its adoption is opposite to the saving of natural resources.

### SUMMARY OF THE INVENTION

With the foregoing problems in view, the present invention has as an object thereof the provision of a rotary cutoff apparatus, which can achieve an improvement in performance by permitting easy speed control without needing high-level skill or technique and can realize efficient operation by permitting easy replacement of an anvil member without requiring high assembling accuracy or much labor.

To achieve the above-described object, a rotary cutoff apparatus according to the present invention is provided with a knife cylinder, which has a knife arranged on an outer circumferential surface thereof and is supported rotatably, and an anvil member with which a free edge of the knife can be brought into contact upon rotation of the knife cylinder, thereby nipping a travelling band-shaped sheet between the knife of the knife cylinder and the anvil member to cut off the band-shaped sheet. The knife is supported on the knife cylinder via a cushioning support mechanism having cushioning force sufficient to bear cutting force required to cut off the band-shaped sheet so that the knife is displaceable in a loaded direction upon cutting off the band-shaped sheet.

The rotary cutoff apparatus according to the present invention has adopted the construction that the knife is supported by the knife cylinder via the cushioning support mechanism. This has made it possible to achieve cutting-off by setting the nipping pressure between the knife and the anvil member at zero or an extremely small value. As a consequence, the abrasion or wear of the knife and anvil member can be completely eliminated or otherwise minimized.

In a conventional anvil-wrapped roll, an anvil layer tends to break up as a result of deepening of indentations or dents in itself or tends to develop deformation such as curving or waving as a result of its ductile elongation during cutting-off or through repeated cutting-off operations, as mentioned above. The rotary cutoff apparatus according to the present invention is however free of such problems, thereby making it possible to maintain its anvil member in a preferred form.

Further, the rotary cutoff apparatus according to the present invention includes only one knife cylinder which is to be accelerated and decelerated. Compared with a rotary cutoff apparatus equipped with two knife cylinders of such a type, the rotary inertia is therefore reduced to a half, thereby making it possible to use a drive means of smaller power output. In addition, the speed of the knife cylinder can be controlled with extreme ease without needing high-level skill or technique for delicate adjustments, thereby making a significant contribution to the improved performance of the apparatus.

### BRIEF DESCRIPTION OF THE DRAWINGS

FIG. 1 is a schematic front view showing a rotary cutoff apparatus according to one embodiment of the present invention, in which some parts have been cut away;

FIG. 2 is a cross-sectional view taken in the direction of arrows II-II of FIG. 1;

FIG. 3 is a cross-sectional view corresponding to the cross-section taken in the direction of arrows II-II of FIG. 1 and illustrating a modification (fluid-filled cushion tube) of the cushioning support mechanism in the rotary cutoff apparatus according to the embodiment;

FIG. 4 is a diagram for describing a permissible lower limit of cutting load by the rotary cutoff apparatus according to the embodiment with a knife supported by the cushioning support mechanism;

FIG. 5 is the schematic front view of the conventional corrugated fiberboard cutoff apparatus;

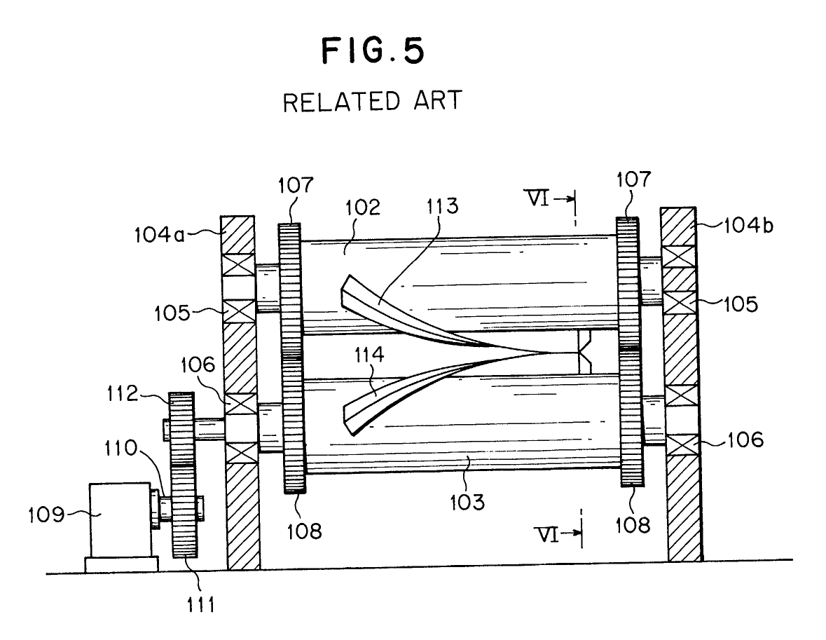

FIG. 6 is the cross-sectional view of the conventional corrugated fiberboard cutoff apparatus taken in the direction of arrows VI-VI of FIG. 5;

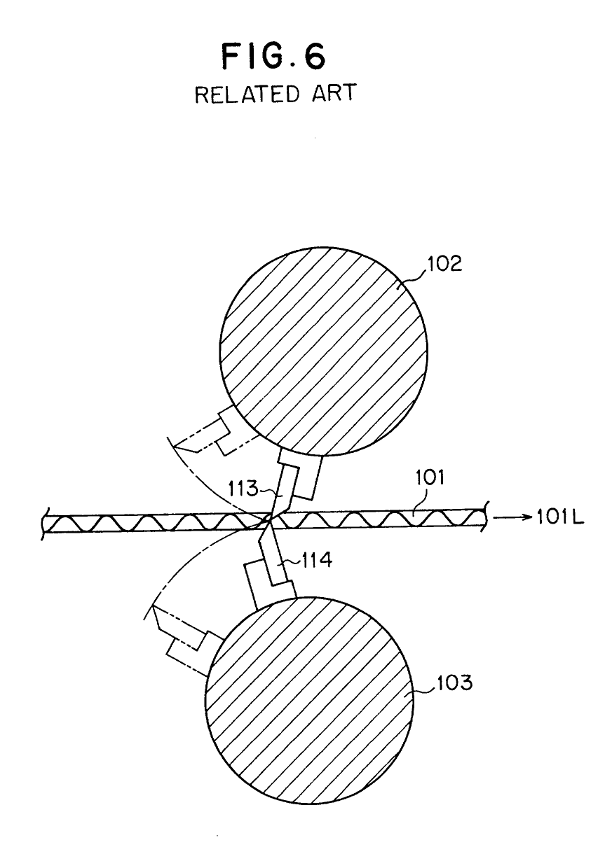

FIG. 7 is the schematic front view of the another conventional corrugated fiberboard cutoff apparatus; and

FIG. 8 is the cross-sectional view of the another conventional corrugated fiberboard cutoff apparatus taken in the direction of arrows VIII-VIII of FIG. 7.

### DETAILED DESCRIPTION OF THE PREFERRED EMBODIMENT

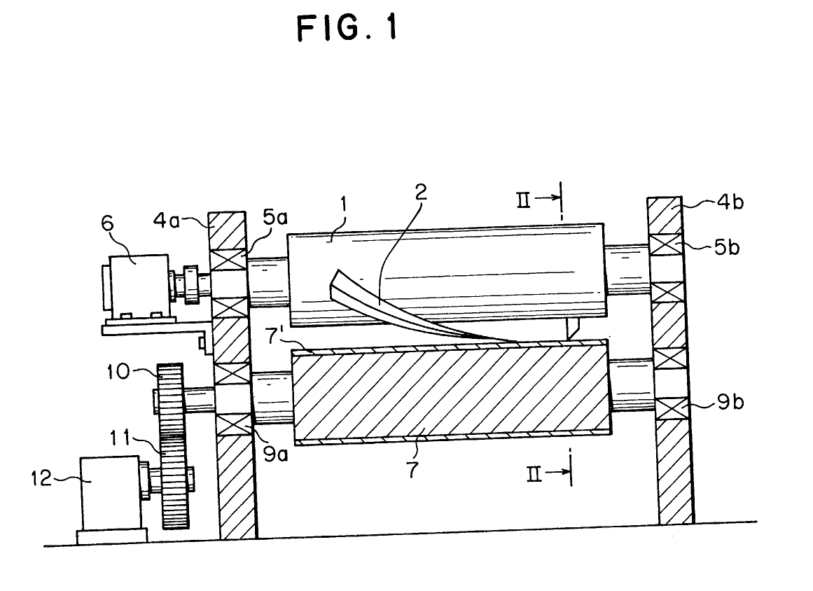

With reference to FIGS. 1 to 4, the embodiment of the present invention will hereinafter be described.

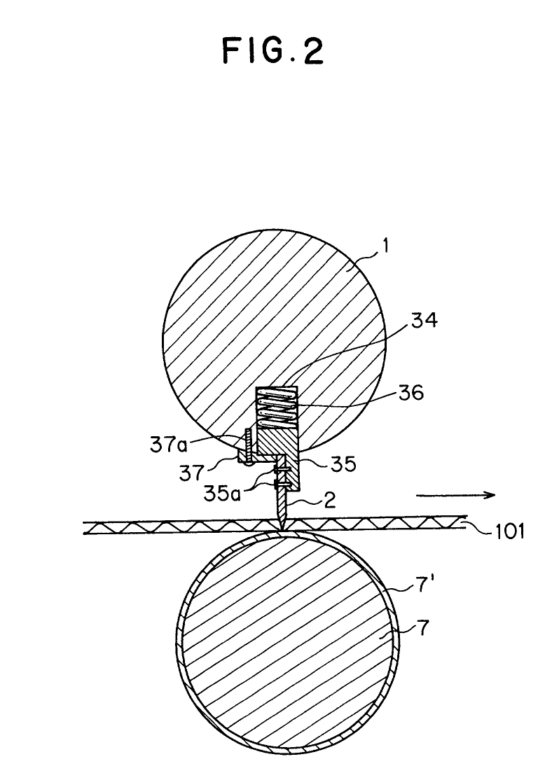

As is illustrated in FIGS. 1 and 2, the rotary cutoff apparatus according to this embodiment is arranged in a production line of a corrugated fiberboard sheet (band-shaped sheet) 101, and is provided with a knife cylinder 1 and a cylindrical anvil member (anvil cylinder) 7. The knife cylinder 1 carries a knife 2 arranged on an outer circumferential surface thereof and is rotatably supported. The anvil member 7 is arranged in parallel with the knife cylinder 1. As the knife cylinder 1 rotates, the knife 2 is successively brought into contact and engagement with the anvil member 7 from an end to an opposite end of the knife 2. The sheet 101, which has been continuously fed and is travelling, is nipped between the knife 2 of the knife cylinder 1 and the anvil member 7, whereby the sheet 101 is cut off.

In this embodiment, the knife 2 is supported on the knife cylinder 1 via a spring (cushioning support mechanism) 36 having cushioning force sufficient to bear cutting force required to cut off the sheet 101 so that the knife 2 is displaceable in a loaded direction upon cutting the sheet 101. Further, the anvil member 7 has been subjected to coating treatment at a surface thereof where the knife 2 can be brought into contact with the anvil member 7, so that a coating layer 7′ is formed to provide the anvil member 7 with an extended service life. This cushioning support mechanism and coating treatment will be described in more detail subsequently herein.

As is illustrated in FIG. 1, the rotary cutoff apparatus according to this embodiment is also provided with frames 4a,4b, an electric motor 6, gears 10,11 and an electric motor 12 in addition to the knife cylinder 1 and the anvil member 7.

As mentioned above, the knife cylinder 1 is rotatably supported with the knife 2 carried on the outer circumferential surface thereof. The knife (cutting edge portion) 2 depicted in the drawings is formed in the shape of a plain blade or hacksaw blade, and is mounted with a lead angle on the outer circumferential surface of the knife cylinder 1. As is depicted in FIG. 2, the knife 2 is mounted in a spiral or helical shape on the knife cylinder 1 via a holder 35. As a material of the knife 2, a WC-Co base hard material (Hv=about 1,000 to about 1,400) can be used, for example.

The knife cylinder 1 with the knife 2 mounted thereon as described above is rotatably supported at opposite ends of a shaft thereof on the frames 4a,4b via bearings 5a,5b, respectively. The electric motor 6 is connected to one of the ends of the shaft so that rotational drive force can be transmitted to the knife cylinder 1.

The knife cylinder 1 in this embodiment is arranged so that the sheet 101 can be cut in predetermined lengths in a direction substantially perpendicular to a feeding direction of the sheet 101. For the construction that the knife 2 has the lead angle, arrangement of the knife cylinder 1 with its central axis crossing at a right angle with the travelling sheet 101 results in a cut line in the form of a line inclined corresponding to the lead angle so that the cut line cannot be formed at a true right angle (in other words, perpendicularly to surfaces of the sheet). It is therefore possible to cut the sheet 101 at a true right angle by arranging the sheet 101 in an position inclined corresponding to the lead angle.

On the other hand, the anvil member 7 is rotatably supported at opposite ends of a shaft thereof on the frames 4a,4b, respectively. One of the ends is connected to the electric motor 12 via the gears 10,11. These gears 10,11 and the electric motor 12 make up a drive system which rotationally drives the anvil member 7 in harmonization with the travelling speed of the sheet 101.

A description will next be made about the cushioning support mechanism of the knife 2. As is depicted in FIG. 2, in the outer circumferential surface of the knife cylinder 1, a groove 34 is formed extending alongside the central axis of the knife cylinder 1. The knife 2, which is secured on the holder 35 by bolts 35a or the like, is arranged in an opening of the groove 34. The knife 2 arranged as described above is supported by a spring 36 in such a way that the knife 2 is movable toward and away from the coating layer 7′ while the holder 35 is allowed to slide in a radial direction of the knife cylinder 1 within the groove 34.

The holder 35 with the knife 2 integrally secured thereon is prevented from popping out of the groove 34 by a stopper 37 secured on the circumferential surface of the knife cylinder 1 by bolts 37a, in other words, the outer stroke end of the holder 35 is defined by the stopper 37.

Because the knife 2 is supported displaceably in the loaded direction upon cutting off the sheet 101 as mentioned above, the pressure of the knife 2 applied to the sheet 101 can be precisely adjusted, in other words, finely controlled in accordance with conditions of the anvil member 7, namely, depending on the conditions of the anvil member 7 in the course of from its arrangement as a fresh anvil member until deterioration of its surface as a result of cutting operations.

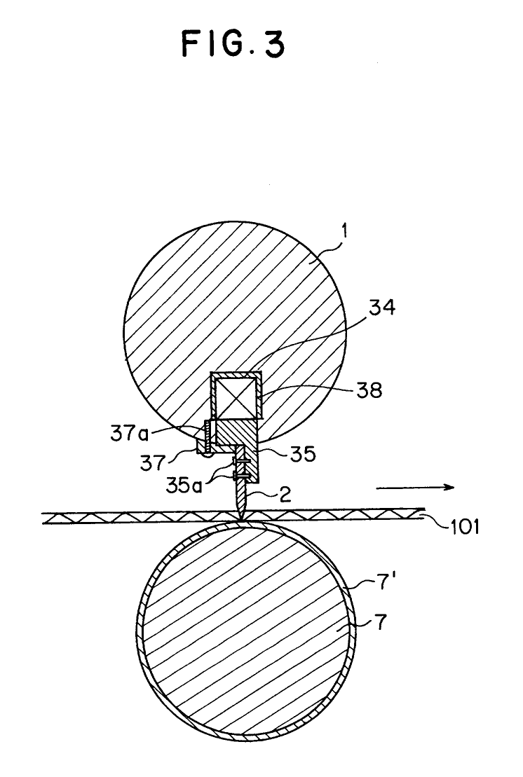

Incidentally, the above-mentioned spring 36 can be set in a preloaded state, in other words, with a provisional compression load applied thereon. As the spring 36, a coned disk spring can be used or, as is shown in FIG. 3, a fluid-filled cushion tube 38 can be used instead of a spring-type cushioning support mechanism. Further, the knife 2 can be provided at a cutting edge portion thereof with an end face as wide as about several hundreds micrometers or so to assure good balancing between durability and cutting performance.

The diameter of the knife cylinder 1, which makes use of the cushioning support mechanism mentioned above, and that of the associated anvil member 7 can be set at 200 to 300 mm.

Further, the coating layer 7′ formed on the outer circumferential surface of the anvil member 7 in this embodiment has been obtained, for example, by subjecting the outer circumferential surface of the anvil member 7 to coating treatment such as spraying while using a hard material such as a carbide cermet composed of a WC-Co base material of the like or a ceramic formed of an Al₂O₃ base material.

According to the rotary cutoff apparatus of the one embodiment of the present invention constructed as mentioned above, upon feeding the sheet 101, the anvil member 7 is rotationally driven in harmonization with the travelling speed of the sheet 101 and, at the same time, the rotation of the knife cylinder 1 is subjected to control by the electric motor 12 via the connecting gears 10,11 so that the knife cylinder 1 is decelerated or accelerated to substantially the same rotational speed as the travelling speed of the sheet 101 to assure initiation of cutting operation by the knife cylinder 1 when the sheet 101 is found to have moved over a predetermined cut length on the basis of a traveled distance of the sheet 101 as measured by an unillustrated detector.

The cutting operation then begins as a result of nipping engagement of the knife 2, which is mounted in the helical form on the knife cylinder 1, with one end of the anvil member 7 with one side edge of the sheet 101 interposed therebetween. This nipping engagement successively proceeds alongside the central axis of the knife cylinder 1 while cutting off the sheet 101, and the cutting operation is completed by their nipping engagement at an opposite side edge of the sheet 101 on the side of the opposite end of the anvil member 9.

The load of the nipping engagement between the knife 2 and the anvil member 7 is substantially reduced by a spring mechanism such as that mentioned above (the spring 36 as the cushioning support mechanism). The arrangement of the knife 2 on the knife cylinder 1 with such a cushioning support mechanism interposed therebetween makes it possible to reduce damage to the anvil member 7.

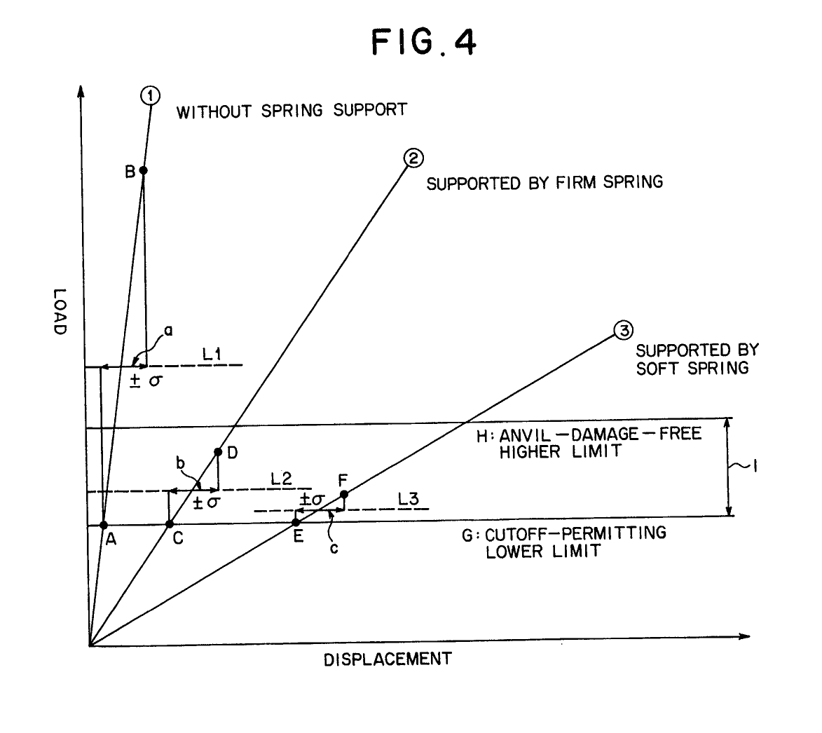

With reference to FIG. 4, a detailed description will hereinafter be made about three cases, one without any spring mechanism, another with a firm spring mechanism employed, and a further with a soft spring mechanism employed. In FIG. 4, loads on each spring mechanism are plotted along the ordinate while displacements of the spring mechanism are plotted along the abscissa.

First, in the case where no spring mechanism is employed (in FIG. 4, line \mathring{1}; without spring support), the load of the nipping engagement between the knife 2 and the anvil member 7 is applied relying upon the main body of the knife cylinder 1 as a solid spring. Incidentally, the main body of the knife cylinder 1 generally shows a spring constant as great as about 15,000 to 18,000 kgf/cm.

Since vibrations associated with rotation, cutting loads and the like cannot be avoided in a mechanical system, the load of nipping engagement between the knife 2 and the anvil member 7 varies in any mechanical system. Now assuming that vibration displacements are within ±σ as shown in FIG. 4, the load of nipping engagement between the knife 2 and the anvil member 7 is set at “L1” level to assure production of a cutting load of at least a cutoff-permitting lower limit (see G in FIG. 4) when no spring mechanism is employed (±σ; see a range a in FIG. 4), because the modulus of rigidity is high, in other words, the displacement-versus-load gradient is steep.

Namely, the load and displacement vary within ranges of from A to B, respectively, when no spring mechanism is employed (see straight line \mathring{1} in FIG. 4). The load may hence significantly exceed an anvil-damage-free higher limit of cutting load (see “H” level in FIG. 4), thereby forming a deep damage in the anvil member 7 and also damaging the knife 2.

When spring mechanisms are employed (in FIG. 4, straight line \mathring{2}: a firm spring is used; straight line \mathring{3}: a soft spring is used), on the other hand, the displacement-versus-load gradient can be set more gentle in each of the cases compared with the above-mentioned case which does not employ any spring mechanism. Even when vibration displacements occur to the same extent as in the above-mentioned case which does not employ any spring mechanism, that is, within ±σ (see ranges b,c in FIG. 4), the ranges of load variations can be reduced to smaller ranges, specifically, to the range of from C to D when the firm spring is employed and to the range of from E to F when the soft spring is employed.

In other words, the load levels “L2”,“L3” of nipping engagement between the knife 2 and the anvil member 7 can be both set at low in the neighborhood of the cutoff-permitting lower limit (see G in FIG. 4). Accordingly, the use of such a spring mechanism makes it possible to set the load level of nipping engagement between the knife 2 and the anvil member 7 within the range of from the cutoff-permitting lower limit to the anvil-damage-free higher limit (see a range I in FIG. 4). As a consequence, the anvil member 7 can be protected from damage.

Incidentally, it is more effective to use, as such a spring mechanism, one having a spring constant adequately chosen depending on the materials making up the knife 2 and the anvil member 7, for example, a spring constant of from 200 to 500 kgf/cm.

It is therefore possible for the rotary cutoff apparatus of this embodiment to cut off the sheet 101 by setting the nipping pressure between the knife 2 and the anvil member 7 at zero or an extremely small value. This makes it possible to completely eliminate or minimize the abrasion or wear of the knife 2 and the anvil member 7, so that the knife 2 and the anvil member 7 can be used over an extended time.

According to the rotary cutoff apparatus according to the above embodiment of the present invention, the knife 2 is supported by the knife cylinder 1 via a cushioning support mechanism such as the spring 36 (or the fluid-filled cushion tube 38). This has made it possible to achieve cutting-off by setting the nipping pressure between the knife 2 and the anvil member 7 at zero or an extremely small value. As a consequence, the abrasion or wear of the knife 2 and anvil member 7 can be completely eliminated or otherwise minimized.

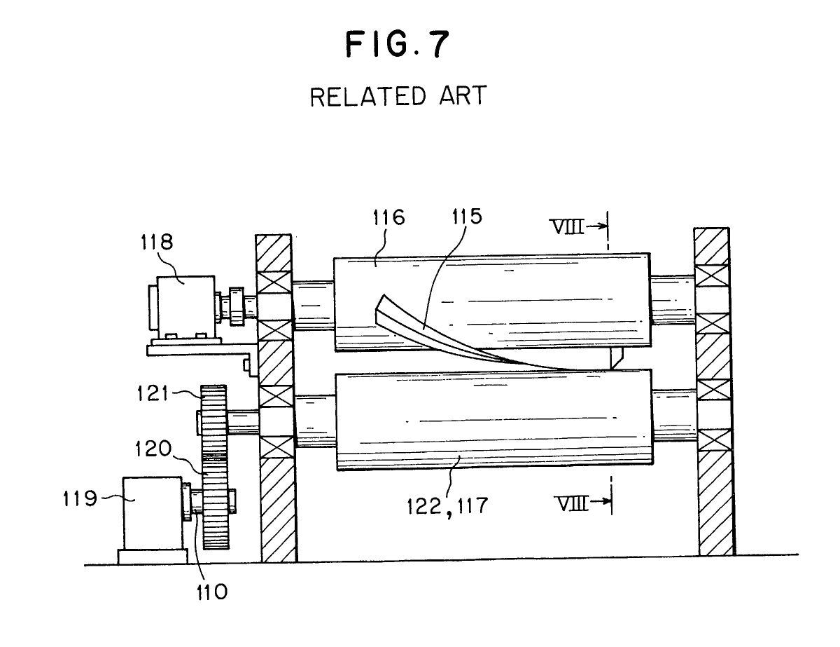

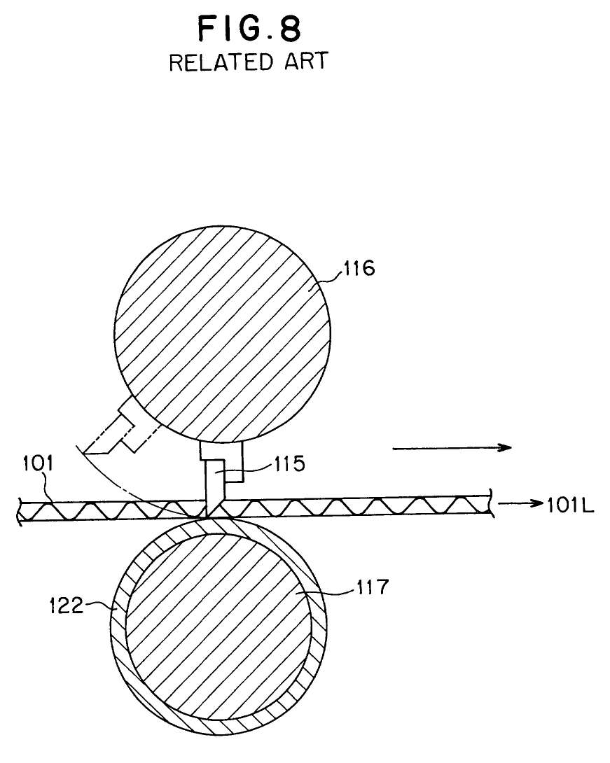

Further, in a conventional anvil-wrapped roll (see numeral 117 in FIGS. 7 and 8), an anvil layer (see numeral 122 in FIGS. 7 and 8) tends to break up as a result of deepening of indentations or dents in itself or tends to develop deformation such as curving or waving as a result of its ductile elongation during cutting-off or through repeated cutting-off operations. The rotary cutoff apparatus according to the above embodiment of the present invention is however free of such problems, thereby making it possible to maintain the anvil member 7 in a preferred form.

Further, the rotary cutoff apparatus according to the above embodiment of the present invention includes only one knife cylinder 1 which is to be accelerated and decelerated. Compared with a rotary cutoff apparatus equipped with two knife cylinders of such a type, the rotary inertia (GD²) is therefore reduced to a half, thereby making it possible to use a drive means (the electric motor 6) of smaller power output. In addition, the speed of the knife cylinder 1 can be controlled with extreme ease without needing high-level skill or technique for delicate adjustments, thereby making a significant contribution to the improved performance of the apparatus.

In addition, the anvil member 7 is provided on the surface thereof with the coating layer 7′. The anvil member (anvil cylinder) 7 is therefore provided with a longer service life. Moreover, work such as wrapping of an anvil layer on and around a cylinder and fitting of the resultant anvil-wrapped roll is no longer needed. The anvil member can be easily replaced. It is therefore possible to achieve efficient operation without needing high assembling accuracy and much labor. Further, the removed anvil member 7 can be reused by simply applying coating treatment to its surface again.

In the above-described embodiment, the band-shaped sheet was the corrugated fiberboard sheet. The present invention is however not limited to such a corrugated fiberboard sheet, and can be applied to other materials insofar as they are in the form of band-shaped sheets. In such applications, the present invention can also bring about similar advantageous effects or merits as the above-described embodiment.

Further, the anvil member 7 was rotationally driven by the electric motor in harmonization with the travelling speed of the sheet 101 in the above-described embodiment. A drive means other than such an electric motor (for example, an engine) is also usable. In such an embodiment, similar advantageous effects or merits can also be obtained.

It is also to be noted that the present invention is not limited to the above-described embodiment and can be practiced by changing or modifying it in various ways to such extents as not departing from the spirit of the present invention.

What is claimed is:

1. A rotary cutoff apparatus provided with a knife cylinder, which has a knife arranged on an outer circumferential surface thereof and is supported rotatably, and an anvil member with which a free edge of said knife can be brought into contact upon rotation of said knife cylinder, thereby nipping a travelling band-shaped sheet between said knife of said knife cylinder and said anvil member to cut off said band-shaped sheet, wherein:
said knife is supported on said knife cylinder via a cushioning support mechanism having cushioning force sufficient to bear cutting force required to cut off said band-shaped sheet so that said knife is displaceable in a loaded direction upon cutting off said band-shaped sheet.

2. A rotary cutoff apparatus according to claim 1, wherein said anvil member has been subjected to coating treatment at a surface thereof where said free edge of said knife can be brought into contact with said anvil member.

3. A rotary cutoff apparatus according to claim 1, wherein said cushioning support mechanism comprises a spring.

4. A rotary cutoff apparatus according to claim 1, wherein said cushioning support mechanism comprises a fluid-filled cushion tube.

5. A rotary cutoff apparatus according to claim 2, wherein said anvil member carries at said surface thereof a coating layer formed by conducting spraying of a hard material as said coating treatment.

6. A rotary cutoff apparatus according to claim 5, wherein said hard material is a carbide cermet.

7. A rotary cutoff apparatus according to claim 5, wherein said hard material is a ceramic.
